(19) United States
(12) Patent Application Publication
(10) Pub. No.: US 2012/0216772 A1
(43) Pub. Date: Aug. 30, 2012

(54) FUEL INJECTOR

(75) Inventor: Nadja Eisenmenger, Stuttgart (DE)

(73) Assignee: ROBERT BOSCH GMBH, Stuttgart (DE)

(21) Appl. No.: 13/503,682

(22) PCT Filed: Oct. 1, 2010
(86) PCT No.: PCT/EP2010/064655

§ 371 Date: Apr. 24, 2012

(30) Foreign Application Priority Data
Nov. 10, 2009 (DE) 10 2009 046 563.4

(51) Int. Cl. F02M 61/04

(52) U.S. Cl. 123/294

(57) ABSTRACT

The invention relates to a fuel injector for injecting fuel into a combustion chamber of an internal combustion engine, in particular a common-rail injector, comprising a control valve (19) for hydraulically connecting a control chamber (13) which is operationally connected to a one or multi-part injection valve element (9) to a low pressure region (8), wherein the control valve (19) comprises a valve element (18) which is axially adjustable by an actuator and interacts with a valve seat (20) in the closed position thereof, to which an axial guide (24) for guiding the valve element (18) in the axial adjustment movement thereof is allocated. According to the invention, a center point (M) of an imaginary circle (26) is arranged within the axial guide length of the guide (24) and the circle contacts the valve seat (20) or the sealing region (31) of the valve element (18) interacting with the valve seat (20) at points, in a longitudinal section plane of the fuel injector (1) accommodating a longitudinal center axis (L) of the valve element (18) of the control valve (19), at two points (P₁, P₂) spaced apart from one another and the center point (M) of the imaginary circle (26) is spaced apart less than 40%, advantageously less than 30%, preferably less than 20%, particularly preferably less than 20% of the axial guide length of the guide (24) from an axial center (25) of the guide (24).

### BACKGROUND OF THE INVENTION

The invention relates to a fuel injector for injecting fuel into a combustion chamber in an internal combustion engine, in particular common rail injector.

For the introduction of fuel into a direct-injection diesel engine, use is presently made of lift-controlled common rail systems. An advantage of these is that the injection pressure is independent of load and rotational speed. Lift-controlled fuel injectors are known which have a control valve, designed as a solenoid valve or piezo valve, for controlling the pressure in a control chamber delimited by an axially adjustable injection valve element. Here, the most modern control valves are of pressure-balanced design, that is to say designed such that, in the closed state, the lowest forces possible, preferably no forces whatsoever, act in the axial direction. The use of pressure-balanced control valves permits the use of lower spring forces, low actuator forces, smaller control valve lifts and therefore faster switching times. As a result of the faster switching times, the capability to carry out multiple injections can be significantly improved.

It is also known to provide internally or externally conical valve seats in control valves of fuel injectors. In order that, in the closed state, the axially adjustable valve element of the control valve always reliably seals off, by means of its sealing region, the valve seat assigned thereto, it is the case in known fuel injectors that the guide for the valve element must be manufactured with the greatest accuracy and close pairing play. This is the case in particular if the seat angle of the internally conical or externally conical seat is selected to be relatively flat, between for example 120° and 180°. As the valve seat angle increases, the self-centering forces that act on the control valve element become lower—the flatter the seat angle, the lower is the downhill-slope force which causes the valve element to slide toward the center.

In contrast to the lower centering forces, however, flat seat angles have the advantage that the control valve exhibits less slip when it abuts against the valve seat, and therefore less wear occurs. It must however be ensured that the control valve element is guided closely and precisely. Since close and precise guides for the control valve element can however be produced only at great expense, it is sought to reach a compromise between maximum sealing action and minimum wear.

### SUMMARY OF THE INVENTION

Taking the above-cited prior art as a starting point, it is the object of the present invention to specify a fuel injector having a control valve, in which the most effective possible sealing of the valve seat of the control valve is provided at the valve seat, and at the same time a comparatively cheap guide for the valve element can be realized.

The invention is based on the consideration that, in practice, it can be assumed that transverse forces act on the valve element of the control valve during operation of the fuel injector, which transverse forces cause the valve element to make contact with the guide at at least one arbitrary point at all times. Here, two extreme positions are conceivable, specifically firstly a fully tilted position in which the valve seat bears both against an upper annular edge of the guide and also, at the opposite side, against a lower annular edge of the guide, and a second extreme position in which the valve element has been displaced completely in parallel and bears against the guide along an axially extending line. The invention is also based on the assumption that the transverse forces acting on the valve element, in particular the transverse forces of a valve spring acting on the valve element, act such that the first alternative (first extreme attitude or position) is more probable, specifically that the valve element will more likely lie in the guide in a fully tilted position, and in so doing be supported both against the uppermost end of the guide and also, at the opposite side, against the lowermost end of the guide.

It can be concluded from this that the control valve should be optimized for the first extreme position, that is to say for the fully tilted valve element, preferably such that the valve element need not slip on the valve seat at all in order to interact sealingly with the valve seat, but rather provides sealing already in the fully tilted position (first extreme position).

The invention achieves this by virtue of the guide for the valve element and the geometric design and arrangement of the valve seat being realized such that an imaginary center of rotation of the valve seat is localized within the axial extent of the guide. The aim of this is to provide that said imaginary center of rotation, to be explained further below, of the valve seat and the center of rotation of the valve element which is arranged on the axial center of the guide come as close to one another as possible. This may be realized in practice by virtue of the attitude and the position of the valve guide being coordinated with the seat angle and the seat diameter.

The abovementioned imaginary center of rotation of the valve seat is formed, as per the definition, by the central point of an imaginary circle which, in a longitudinal central portion which encompasses the longitudinal central axis of the valve element, makes contact with the valve seat, preferably two surface portions of the valve seat which run at an angle with respect to one another, in a punctiform manner in each case, preferably in such a way that the imaginary circle does not intersect any of the seat surfaces. This is in turn based on the assumption that, at small tilt angles of less than 1°, the preferably conical valve seat behaves approximately in the manner of a ball. Under this assumption, therefore, the imaginary circle is the circle of rotation on which the valve element moves as it tilts. Furthermore, the invention is based on the assumption that the valve seat, by means of a valve spring force and the material elasticity, is capable of closing off a certain gap, as a result of which, with the arrangement according to the invention of the imaginary center of rotation of the valve seat, the sealing action of the control valve can be ensured in all extreme positions.

The greater the precision with which the guide is manufactured, that is to say the smaller the guide play is, the more leak-tight the control valve is also in the second, parallel-offset extreme position of the valve element.

In the first solution variant discussed above, in which the axis of rotation of the valve seat and the center of rotation of the valve element are situated as close to one another as possible in the first extreme position, the valve seat and the guide are arranged positionally fixedly relative to one another in the fuel injector.

The object is also achieved by means of a second alternative, which differs from the first alternative merely in that, here, the imaginary circle makes contact with the sealing region, which is formed on the valve element, at two spaced-apart points in a punctiform manner (and preferably does not intersect the sealing region), and in that the central point of said circle is an imaginary center of rotation of the sealing region of the valve element. In the second alternative, the sealing region and the guide are formed so as to be positionally fixed relative to one another, which may be realized by virtue of the sealing region and the guide being formed by the valve element. In the second alternative, too, it is assumed that the imaginary circle is the circle of rotation on which the valve element moves as it tilts in the closed state, that is to say when the sealing region is in contact with the valve seat. It is very particularly preferable if, in the second alternative, the sealing region is formed as an internal or external cone and, in the longitudinal sectional view of the fuel injector, two spaced-apart, linear sealing region surface portions form in each case one tangent to the imaginary circle.

It is also provided according to the invention that the central point of the imaginary circle which makes contact with the valve seat at two spaced-apart points in a punctiform manner in each case and which preferably does not intersect the seat surface, that is to say the imaginary center of rotation of the valve seat, is arranged as close as possible to the axial center, that is to say the center of rotation of the valve element in the first extreme position (contact against the upper guide edge and contact again the opposite, lower guide edge). The spacing between the central point of the circle and the axial center of the guide is very particularly preferably less than 40% of the axial guide length, in particular less than 30%, preferably less than 20%, particularly preferably less than 10% and very particularly preferably less than 5%. The same applies in the second alternative to the imaginary circle which makes contact with the sealing region at two points in a punctiform manner and which preferably does not intersect the sealing surface.

It is very particularly preferable for the central point of the imaginary circle (first or second alternative) to be arranged at the mid-point of the guide length, that is to say in the axial center of the guide, and to therefore preferably coincide with the center of rotation, mentioned numerous times above, of the valve element in the first extreme position.

If the central point of the imaginary circle (in the first or second alternative) is spaced apart axially from the axial center of the guide, it is preferable for the central point to be situated at an axial height of the guide which lies between the axial center and that end of the guide which faces toward the valve seat.

It is particularly expedient if the central point of the imaginary circle (in the first or second alternative) is arranged on a longitudinal central axis of the guide.

It is particularly expedient for the valve seat or the sealing region of the valve element to be of conical design. Here, it is alternatively possible to realize internal or external cone seats, wherein in the case of the internally conical valve seat and sealing region, the valve element interacts with internally conical surfaces, and in the case of the external cone valve seat, the valve element interacts with externally conical valve seat surfaces and sealing region surfaces.

It is very particularly expedient if the cone angle of the valve seat or of the sealing region, that is to say the angle which, in the longitudinal sectional plane, which encompasses the longitudinal central axis of the valve element, of the fuel injector, span two spaced-apart, obliquely running valve seat surface portions or sealing region surface portions which are linear in the sectional view.

In the case of the valve seat or the sealing region being formed as an external or internal cone, it is preferable for the imaginary circle to make contact with two valve seat surface portions or sealing region surface portions, which run at an angle with respect to one another, in a punctiform manner such that said surface portions form in each case a tangent to the imaginary circle, that is to say run in each case orthogonally with respect to the radius.

Each cone has an internal cone side and an external cone side, wherein internally conical valve seats or sealing regions sealingly interact with the valve element by means of their internal cone side, and external cone valve seats or external cone sealing regions sealingly interact with the valve element by means of their external cone side. It is particularly expedient for the axial guide for the valve element to be arranged on the internal cone side of the valve seat or sealing region, regardless of whether the valve seat or sealing region is an external cone or an internal cone.

A design variant is particularly expedient in which the control valve is formed as a valve which is axially at least approximately pressure-balanced when in the closed state. One possibility for this consists in the valve element being formed as a sleeve which, radially at the inside, delimits a valve chamber which is hydraulically connected to the control chamber, which valve chamber is connected to the low-pressure region when the control valve is open. It is however also possible for pin-shaped control valve elements to be designed to be axially pressure-balanced by virtue of the abovementioned valve chamber being provided in the form of an annular groove on the outer circumference of the pin.

### BRIEF DESCRIPTION OF THE DRAWINGS

Further advantages, features and details of the invention will emerge from the following description of preferred exemplary embodiments and on the basis of the drawings, in which:

FIG. 1 shows a first exemplary embodiment of a fuel injector, only a detail of which is illustrated, having a control valve, in which the valve element is designed as a sleeve and, in the closed position, sealingly interacts with an internally conical valve seat,

FIG. 2 shows an alternative design of a control valve having a pin-shaped valve element and having a valve chamber arranged on the outer circumference,

FIG. 3 shows a further alternative exemplary embodiment of a control valve having a pin-shaped valve element which, on the outer circumference, has an annular-groove-like depression which forms the valve chamber which is connected to the control chamber, wherein the valve seat is in the form of an external cone, and

FIG. 4 shows a further alternative exemplary embodiment of a control valve, in which the valve element is of sleeve-shaped design and the imaginary circle makes contact with an internally conical sealing region of the valve element in a punctiform manner, and wherein the valve seat is arranged on an axial extension, which projects into the valve element, of a restrictor plate and interacts with a guide formed on the valve element.

### DETAILED DESCRIPTION

In the figures, identical elements and elements of identical function are denoted by the same reference numerals.

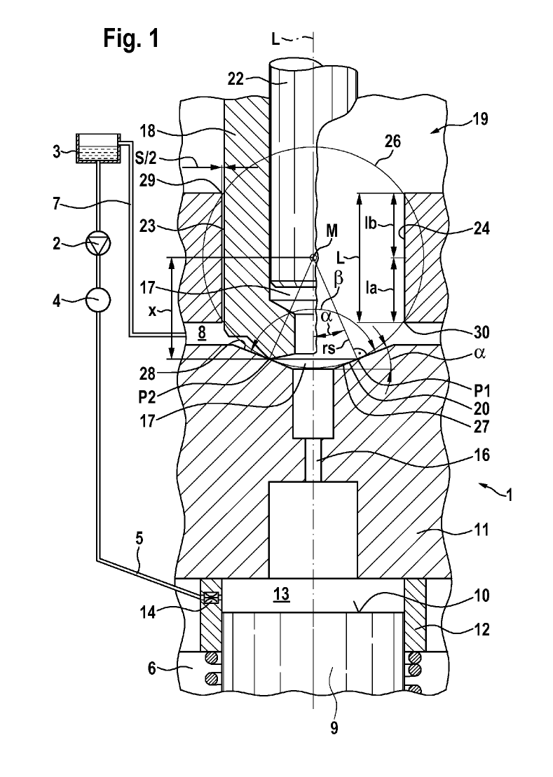

FIG. 1 is a highly schematic illustration, showing only a detail, of a fuel injector 1, which is designed as a common rail injector, for injecting fuel into a combustion chamber of an internal combustion engine (not illustrated) of a motor vehicle. A high-pressure pump 2 delivers fuel from a storage vessel 3 into a fuel high-pressure accumulator 4 (rail). In the latter, fuel, in particular diesel, is stored at high pressure, approximately 2000 bar in this exemplary embodiment. The fuel injector 1 is connected, along with other fuel injectors (not shown), to a fuel high-pressure accumulator 4 via a supply line 5. The supply line 5 opens into a pressure chamber 6. A low-pressure region 8 of the fuel injector 1 is connected to the storage vessel 3 via a return line 7. A control quantity of fuel, to be explained further below, can flow from the fuel injector 1 to the storage vessel 3 via the return line 8.

A single-part or multi-part injection valve element 9 is arranged in an axially adjustable manner within an injector body. The injection valve element 9 has, at a tip (not illustrated), a closing surface by means of which the injection valve element 9 can be placed in sealing contact with an injection valve element seat formed within a nozzle body (not shown).

When the injection valve element 9 bears against its injection valve element seat, that is to say is situated in the closed position, the flow of fuel out of a nozzle hole arrangement (not shown) is blocked. In contrast, when the injection valve element is raised from its injection valve element seat, fuel can flow out of the pressure chamber 6 through the nozzle hole arrangement and into the combustion chamber of the internal combustion engine.

An upper end side 10 of the injection valve element 9 and a spring-loaded sleeve 12 which is supported axially on a restrictor plate 11 delimit a control chamber 13 (servo chamber) to which highly pressurized fuel from the pressure chamber 6 is supplied via an inflow restrictor 14 formed in the sleeve 12. The control chamber 10 is connected, via an outflow duct 15 with an outflow restrictor 16 (outflow duct 15 and outflow restrictor 16 are situated within the restrictor plate 11), to a valve chamber 17 which is delimited radially at the outside by a sleeve-shaped valve element 18 (control valve element) of a control valve 19. In the illustration of FIG. 1, the control valve 19 is shown in a sectional view in the left-hand half of the drawing, and only the dimensions of a guide, to be explained further below, for the valve element 18 are shown in the right-hand half of the drawing.

Fuel can flow from the valve chamber 17 into the low-pressure region 8 of the fuel injector when the valve element 18, which can be actuated by an electromagnetic actuator, is raised from its valve seat 20 (control valve seat) which is formed as an internal cone and which is arranged on the restrictor plate 11, that is to say when the control valve 19 is opened. Here, the throughflow cross sections of the inflow restrictor 14 and of the outflow restrictor 15 are coordinated with one another such that, when the control valve 19 is open, there is a net outflow of fuel (control quantity) out of the control chamber 13 via the valve chamber 17 into the low-pressure region 8 of the fuel injector 1, and from there via the return line 7 into the storage vessel 3.

In the exemplary embodiment shown, the control valve 19 is designed as a valve which is pressure-balanced in the axial direction when in the closed state, wherein the valve element 18 is integrally connected, in its upper portion, to an armature plate (not illustrated) which interacts with an electromagnetic actuator (not illustrated). When the actuator is supplied with electrical current, the sleeve-shaped valve element 18 is raised from its internally conical valve seat 20, as a result of which the pressure within the control chamber 13 falls rapidly, and the injection valve element 9 moves in the axial direction, upward in the plane of the drawing, into the sleeve 12, as a result of which the injection valve element 9 is raised from its injection valve element seat and fuel can flow into the combustion chamber. To end the injection process, the supply of electrical current to the electromagnetic actuator is stopped and a closing spring (valve spring, control closing spring) (not shown) which acts in the axial direction on the valve element 18 moves the sleeve-shaped valve element 18 back onto its valve seat 20. As a result of the follow-up flow of fuel through the inflow restrictor 17, the pressure in the control chamber 13 increases rapidly, as a result of which the injection valve element 9, assisted by the spring force of a closing spring 21 which is supported on a circumferential collar (not illustrated) of the injection valve element 9, is moved in the direction of the injection valve element seat, as a result of which the flow of fuel out of the nozzle hole arrangement into the combustion chamber is stopped.

A pin 22 projects into the sleeve-shaped valve element 18 from the top downward, which pin has the task of sealing off the valve chamber 17 in the upward axial direction. The diameter of the pin 22 corresponds at least approximately to the diameter of the annular sealing line at which the valve element 18 interacts with the internally conical valve seat 20.

As can be seen from FIG. 1, the valve element 18 is guided at its outer circumference in a circular-ring-shaped contoured guide bore 23 which forms the guide 24 for the valve element 18. The guide 24 has the axial length L. In the exemplary embodiment shown, the axial center 25 of the guide 24 lies on a longitudinal central axis L of the valve element 18 and at the level of the mid-point of the axial extent (I/2=Ia=Ib) of the guide 24.

In the longitudinal sectional plane shown which encompasses the longitudinal central axis L, an imaginary circle 26 is arranged so as to make contact with the valve seat 20 in a punctiform manner at two points P₁ and P₂ spaced apart in the radial direction, wherein the circle 26 does not intersect the valve seat 20. Two spaced-apart valve seat surface portions 27, 28 which enclose an internal cone angle β form in each case a tangent to the circle 26, such that the radius rₛ of the circle 26 is at right angles to the valve seat 20, more precisely to the valve seat surface portions 27, 28, at the points P₁ and P₂. The relationship β+2α=180° applies, where the angle a is the slope angle by which the valve seat surface portions 27, 28 are inclined relative to a plane running perpendicular to the longitudinal central axis L. It can be seen that the central point M of the above-described circle 26 is situated within the axial extent of the guide 24, even on the longitudinal central axis L in the exemplary embodiment shown. In the exemplary embodiment shown, the central point M, that is to say an imaginary center of rotation of the valve seat 20, coincides with the axial center 25 of the guide 24, wherein the axial center 25 constitutes a center of rotation of the valve element 18 in a first extreme position in which the valve element 18 bears both against an upper annular edge 29 of the guide 24 and also, at the opposite side, against a lower annular edge 30 of the guide.

Also shown in the drawing is the guide play S/2 between the valve element 18 and guide 23.

From the values rₛ (radius of the circle 26) and the slope angle α, it is possible to calculate the axial spacing x between the sealing line, that is to say at the actual seat, and the center of rotation M of the valve seat.

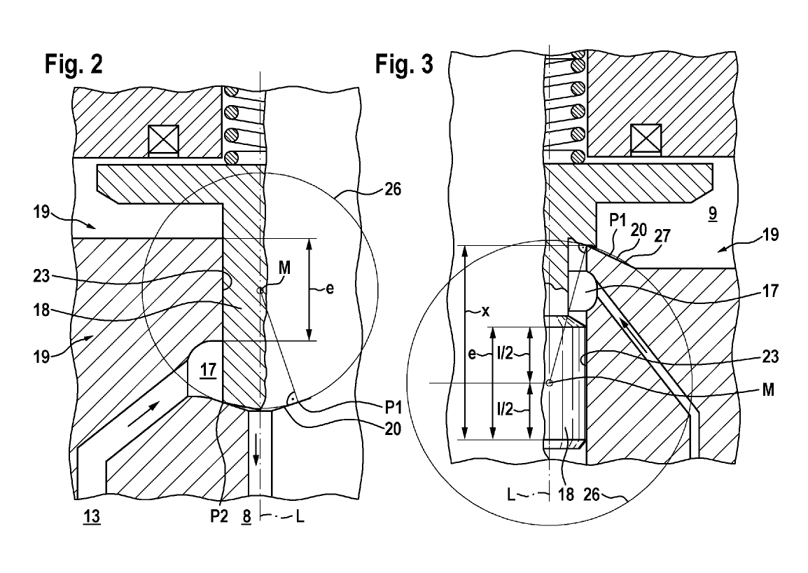

FIG. 2 shows an alternative exemplary embodiment of a control valve 19, wherein to avoid repetitions, substantially only the differences in relation to the exemplary embodiment according to FIG. 1 will be discussed. With regard to common features, reference is made to the exemplary embodiment above.

It can be seen that the valve element 18 is designed not in the form of a sleeve but rather as a pin which is guided in a guide 23 with the axial extent I. The central point M of a circle 26, which is arranged similarly to the exemplary embodiment according to FIG. 1 and which, as in FIG. 1, is situated on the internal cone side of the valve 20, is arranged at the axial center (I/2).

Situated on the outer circumference of the cylindrical, pin-shaped valve element 18 is the valve chamber 17 which is formed as an annular chamber and into which fuel from the control chamber 13 flows obliquely from the outside and, when the control valve is open, flows out downward in the axial direction to a low-pressure region 8.

FIG. 3 shows a further exemplary embodiment. Here, the valve seat 20 is in the form of an external cone and the guide 23 for the pin-shaped valve element 18 and the circle 26 are situated on the (in this case downwardly directed) internal cone side of the externally conical valve seat 20, which with its external cone side interacts sealingly with the valve element. The valve seat surface portions 27, 28 form tangents to the circle 26. It can be seen that the central point of the circle is arranged within the axial extent L of the guide 23 at L/2, specifically on the longitudinal central axis L of the valve element 18. In contrast to the exemplary embodiment according to FIG. 2, the valve chamber 17 is formed in the manner of an annular groove into the outer circumference of the valve element 18, and when the control valve 19 is open, fuel can flow out of the valve chamber 17, likewise into a low-pressure region 9, not downward in the plane of the drawing as in FIG. 2, but rather upward in the plane of the drawing.

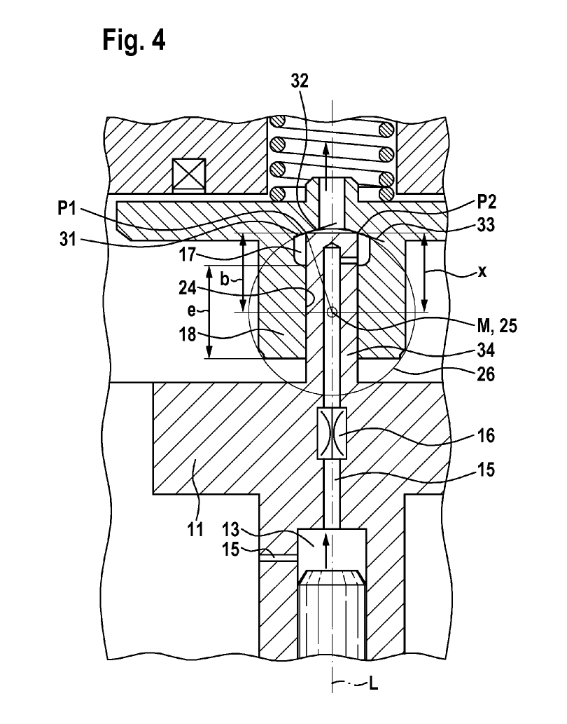

The exemplary embodiment according to FIG. 4 fundamentally differs from the above exemplary embodiments because it is not the static valve seat but rather the sealing region 31, which is formed on the valve element and which interacts with the valve seat in the sealing position, that is of conical form, in this case of internally conical form (alternatively externally conical form). Similarly to the above exemplary embodiments, the circle 26 lies on the internal cone side of the internally conical sealing region 31 of the valve element 18 and makes contact with the sealing region 31 at two spaced-apart points P₁ and P₂, such that in the longitudinal sectional view, two linear sealing region portions 32, 33 which enclose an internal cone angle β make tangential contact with the circle 26. The central point M of the circle 26 lies at the axial center 25 of the guide 24, which in the exemplary embodiment shown is formed or defined by the valve element 18. With the guide 24, the valve element 18 slides axially along an axial extension 34 of the restrictor plate 11.

In the exemplary embodiment shown, the valve chamber 17 is situated on the outer circumference of the extension 34 as an inner annular groove within the sleeve-shaped valve element 18.

1. A fuel injector (1) for injecting fuel into a combustion chamber of an internal combustion engine, the fuel injector comprising: a control valve (19) for hydraulically connecting a control chamber (13), which is operatively connected to an injection valve element (9), to a low-pressure region (8), wherein the control valve (19) comprises a valve element (18) which can be adjusted axially by means of an actuator and which, in a closed position, interacts via a sealing region (31) with a valve seat (20), which valve element is assigned an axial guide (24), which is arranged positionally fixedly with respect to the sealing region (31) or with respect to the valve seat (20), for guiding the valve element (18) during axial adjusting movement, characterized in that a central point (M) of an imaginary circle (26) is arranged within an axial guide length of the guide (24) and in that, in a longitudinal central plane, which encompasses a longitudinal central axis (L) of the valve element (18) of the control valve (19) of the fuel injector (1), the circle (26) intersects the valve seat (20), or the sealing region (31) which interacts with the valve seat (20), of the valve element (18) at two spaced-apart points (P₁, P₂) in a punctiform manner, and in that the central point (M) of the imaginary circle (26) is spaced apart from an axial center (25) of the guide (24) by less than 40%, of the axial guide length of the guide (24).

2. The fuel injector as claimed in claim 1, characterized in that the central point (M) of the imaginary circle (26) is arranged at least approximately at the axial center (25) of the guide (24).

3. The fuel injector as claimed in claim 1, characterized in that the central point (M) of the imaginary circle (26) is arranged axially between the axial center (25) of the guide (24) and an end of the guide (24) which faces toward the valve seat (20).

4. The fuel injector as claimed in claim 1, characterized in that the central point (M) of the imaginary circle (26) is arranged on the longitudinal central axis (L) of the axial guide (24).

5. The fuel injector as claimed in claim 1, characterized in that the valve seat (20) or the sealing region (31) of the valve element (18) is formed as an internal or external cone.

6. The fuel injector as claimed in claim 5, characterized in that a cone angle of the valve seat (20) or of the sealing region (31) is selected from an angle range of between approximately 140° and approximately 170°.

7. The fuel injector as claimed in claim 5, characterized in that, in the longitudinal central plane of the fuel injector (1), two linear valve seat surface portions (27, 28), or two linear sealing region portions (32, 33), arranged with a cone angle with respect to one another, form a tangent to the imaginary circle (26).

8. The fuel injector as claimed in claim 5, characterized in that the axial guide (24) is arranged on an internal cone side of the externally conical or internally conical valve seat (20) or of the sealing region (31).

9. The fuel injector as claimed in claim 1, characterized in that the control valve (19) is formed as a valve which is axially at least approximately pressure-balanced when in the closed position.

10. The fuel injector as claimed in claim 1, characterized in that the fuel injector is a common rail fuel injector.

11. The fuel injector as claimed in claim 1, characterized in that the injection valve element (9) is a single-part injection valve element.

12. The fuel injector as claimed in claim 1, characterized in that the injection valve element (9) is a multi-part injection valve element.

13. The fuel injector as claimed in claim 1, characterized in that the central point (M) of the imaginary circle (26) is spaced apart from an axial center (25) of the guide (24) by less than 30% of the axial guide length of the guide (24).

14. The fuel injector as claimed in claim 1, characterized in that the central point (M) of the imaginary circle (26) is spaced apart from an axial center (25) of the guide (24) by less than 20% of the axial guide length of the guide (24).
